(19) United States
(12) Patent Application Publication
(10) Pub. No.: US 2010/0295771 A1
(43) Pub. Date: Nov. 25, 2010

(54) CONTROL OF DISPLAY OBJECTS

(75) Inventors: Nicholas Burton, Hemington (GB); William Bryan, Ashby de la Zouch (GB); Andrew Wilson, Ashby de la Zouch (GB)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/468,964

(22) Filed: May 20, 2009

(51) Int. Cl. G06T 7/20; G09G 5/00

(52) U.S. Cl. 345/156; 382/103

(57) ABSTRACT

Disclosed herein are systems and methods for controlling display objects. Particularly, a body part of a user may move, and the movement detected by a capture device. The capture device may capture images or frames of the body part at different times. Based on the captured frames, velocities of the body part may be determined or at least estimated at the different times. A blend velocity for the body part may be determined based on the different velocities. Particularly, for example, the blend velocity may be an average of the velocities of the body part over a period of time. A display object may then be controlled or moved in accordance with the blend velocity. For example, an avatar's body part may be moved in the same direction as a recent captured frame of the user's body part, and at the blend velocity.

### BACKGROUND

Many computing applications such as computer games, multimedia applications, or the like use controls to allow users to manipulate avatars, game characters, cursors, windows, and various other display objects. Typically, such controls are input using, for example, game controllers, remotes, keyboards, mice, or the like. Unfortunately, such controls can be difficult to learn, thus creating a barrier between users and control of display objects in such games and applications.

In particular, the user actions required for operating such controls do not correspond to the movements of the display object being controlled. For example, a user may depress a button on a controller for causing an avatar's arms to move upward or the like. Thus, in this example, the action of the user is not the same as the resulting action of the avatar. It is desirable in many games or other applications for a user to be able to accurately control a display object by making a movement or action.

### SUMMARY

Disclosed herein are systems and methods for controlling display objects within a display environment. The display object, such as an avatar, game character, cursor, window or the like, may be controlled based on movement of a user. According to an example embodiment, the user may make one or more physical movements for causing a corresponding movement of the display object. For example, the user may raise one of his or her arms and, as a result, the display object may move upwards on a display. The user's movements may be detected by a capture device, the detected movements analyzed and processed, and the corresponding movements of the display object displayed on an audiovisual display.

Particularly, in accordance with the subject matter disclosed herein, movement of a user may be detected by a capture device. The capture device may capture images or frames of one or more of the user's body parts at different times. Based on the captured frames, velocities of a body part may be determined or at least estimated over a period of time. A blend velocity for the body part may be determined based on the previous velocities determined for the body part. Particularly, for example, the blend velocity may be an average of the velocities of the body part over a period of time. A display object or a displayed avatar's body part may then be moved in accordance with the blend velocity. In this manner, for example, blend velocities may be determined for multiple body parts of the user, and the avatar moved in accordance with the blend velocities over a series of frames. Noise associated with the detected movement of a user may be suppressed by moving the avatar in accordance with the blend velocities. As a result, jitter or abrupt movements of the avatar or display object are avoided or substantially reduced.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for controlling display objects in accordance with this specification are further described with reference to the accompanying drawings in which:

FIGS. 1A and 1B illustrate an example embodiment of a configuration of a target recognition, analysis, and tracking system with a user playing a boxing game;

FIG. 2 illustrates an example embodiment of a capture device;

FIG. 3 illustrates an example embodiment of a computing environment that may be used to control movement of an avatar based on one or more user movements in a physical space;

FIG. 4 illustrates another example embodiment of a computing environment that may be used to control movement of an avatar based on one or more user movements in a physical space;

FIG. 5 depicts a model of a user that may be created using the capture device and the computing environment;

FIG. 6 depicts a flow diagram of an example method for controlling movement of the avatar based on movement of the user;

FIG. 7 depicts a flow diagram of an example method for controlling movement of a body part of the avatar based on movement of another body part; and

FIGS. 8 and 9 are screen displays of an avatar facing a user along with graphics of velocity magnitudes of the wrist movement and their averages over a period of time.

### DETAILED DESCRIPTION OF ILLUSTRATIVE EMBODIMENTS

As will be described herein, a user may control a display object, such as an avatar, game character, cursor, window or the like, by making a movement or action with his or her body. According to one embodiment, the user may make one or more physical movements for causing a corresponding movement of an avatar. For example, the user may raise one of his or her arms and, as a result, the same arm of the avatar will similarly raise. The user's movements may be detected by a capture device, the detected movements analyzed and processed, and the corresponding movements of an avatar displayed on an audiovisual display. In addition, noise in the movements captured by the capture device may be reduced or eliminated such that the movements of the avatar are not jittery or erratic.

Particularly, in accordance with the subject matter disclosed herein, movement of a user may be detected by a capture device. The capture device may capture images or frames of one or more of the user's body parts at different times. For example, the captured frames may include the user's wrist movement. Based on the captured frames, velocities of a body part may be determined or at least estimated over a period of time. A blend velocity for the body part may be determined based on the previous velocities determined for the body part. Particularly, for example, the blend velocity may be an average of the velocities of the body part over a period of time. A displayed avatar's body part may then be moved in accordance with the blend velocity. For example, the avatar's body part may be moved at the blend velocity in the same direction as a recent captured frame of the user's body part. In this manner, blend velocities may be determined for multiple body parts of the user, and the avatar moved in accordance with the blend velocities over a series of frames. As described in more detail herein, noise associated with the detected movement of a user may be suppressed by moving the avatar in accordance with the blend velocities. As a result, jittery or abrupt movements of the avatar can be avoided or substantially reduced.

In an embodiment, user movements may be detected by, for example, a capture device. For example, the capture device may capture a depth image of a scene. In one embodiment, the capture device may determine whether one or more targets or objects in the scene correspond to a human target such as the user. The capture device may determine the depth to the user's body parts at different times. In addition, the capture device may model the user and identify body parts of the user. Each identified body part may be scanned to generate a model such as a skeletal model, a mesh human model, or the like associated therewith. The model may then be provided to the computing environment such that the computing environment may track the model, render an avatar associated with the model, determine clothing, skin and other colors based on a corresponding RGB image, and/or determine which controls to perform in an application executing on the computer environment based on, for example, the model. The computing environment may also determine and store velocities of the body parts over a period of time to use in determining blend velocities for moving body parts of the avatar.

In an example embodiment of displaying an avatar, the avatar may be shown from a third-person view perspective of over-the-shoulder of the avatar. The view perspective may stay from a position behind the avatar, such as a user feels like the on-screen avatar is mimicking the user's actions. This view perspective may remove any ambiguity, from the user's perspective, between right and left, meaning the user's right is the avatar's right, and the player's left is the avatar's left.

In another example embodiment of displaying an avatar, the avatar may be facing the view of the user. The displayed avatar may precisely or closely mimic the detected movements of the user, such as a user feels like the avatar's movements are a mirror image of the user's movements. The system may monitor registration points on a user's skeletal model for tracking user movement. The avatar's movement may be controlled to mimic movement of the user's skeletal model. Particularly, when a registration point of the user's skeletal model moves, the avatar may make a corresponding movement in real-time or near real-time. The movements may be mapped directly onto a corresponding point of the user's avatar. The movements may be scaled so that the movements are correct regardless of the difference in proportion between the user's skeletal model and the avatar model.

In accordance with an example embodiment, movement filters may be applied to suppress noise in the movement of registration points on a user's skeletal model, such that the movement of a corresponding point on the avatar appears smooth. If movement of a wrist point on a skeletal model is noisy, the movement filter may adaptively suppress the noise. For example, when a registration point moves, the movement filter may analyze the velocity of the registration point's movement, and smooth the movement by using the averaged or blended movement of the registration point over the past as the movement of the avatar. According to an embodiment, the registration point may be considered to be in a steady state if the mean velocity of the registration point over a number of frames tends to zero. In the instance of steady state, movement of the corresponding point of the user's avatar may be held in a steady position corresponding to the position of the skeletal model's registration point.

In another example of suppressing skeletal model noise, when a registration point moves, a movement filter may analyze the velocity of the registration point's movement. The registration point may be considered to be in a moving state if the mean velocity of the registration point is other than zero. In the instance of a moving state, movement of the corresponding point of the user's avatar may be moved at a velocity that is the mean of the velocity of the skeletal registration point over a number of previously captured frames. It can be expected that the mean velocity of the user's skeletal model should tend to the actual velocity of the user's movement, such that the avatar's movement accurately represents the user's movement but without noise. The movement filters may allow filtering analysis to be specified on a per-bone and/or per-joint basis.

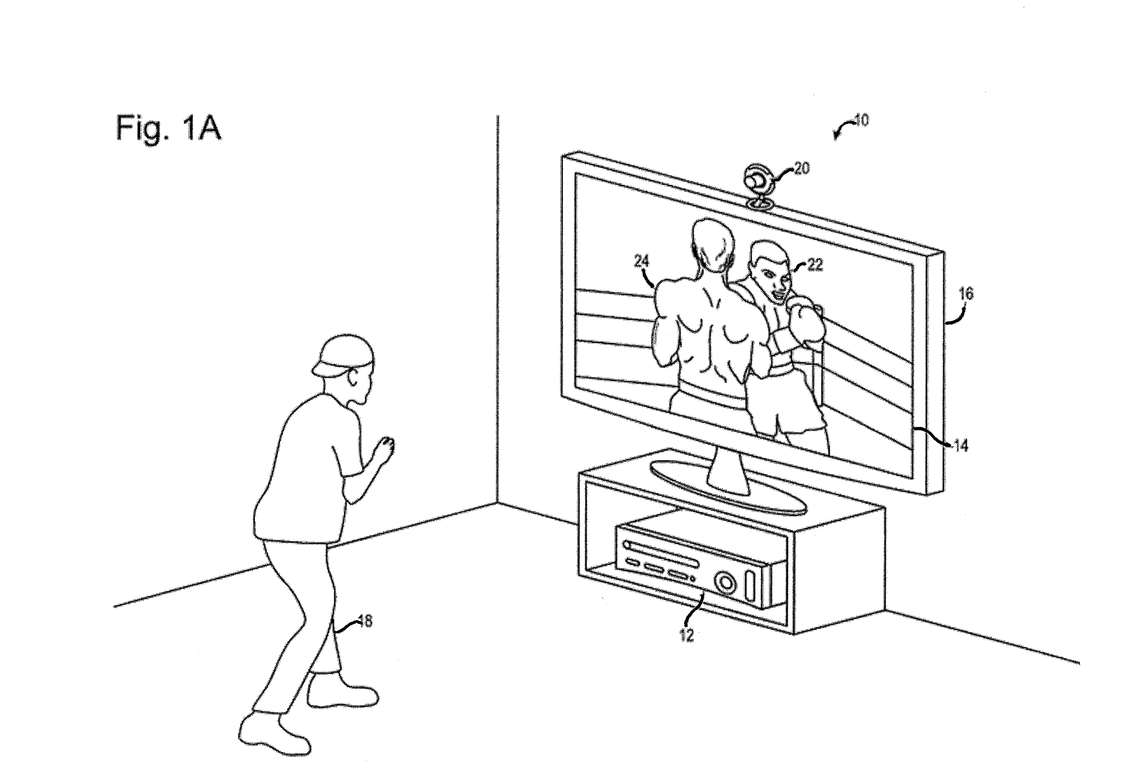

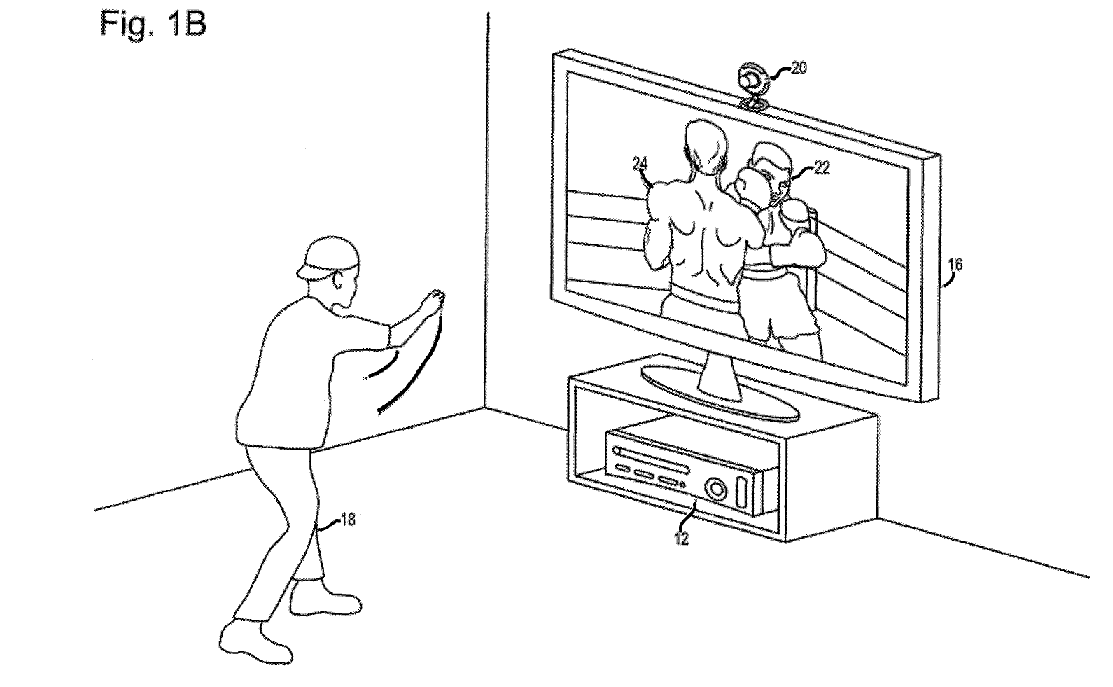

FIGS. 1A and 1B illustrate an example embodiment of a configuration of a target recognition, analysis, and tracking system 10 with a user 18 playing a boxing game. In the example embodiment, the system 10 may recognize, analyze, and track movements of a user 18 for controlling movements of an avatar 24. Movement filters may be applied to adaptively suppress noise within model joint positions captured by the system 10 such that movement of the avatar 24 appears smooth.

As shown in FIG. 1A, the system 10 may include a computing environment 12. The computing environment 12 may be a computer, a gaming system, console, or the like. According to an example embodiment, the computing environment 12 may include hardware components and/or software components such that the computing environment 12 may be used to execute applications such as gaming applications, non-gaming applications, and the like.

As shown in FIG. 1A, the system 10 may include a capture device 20. The capture device 20 may be, for example, a detector that may be used to monitor one or more users, such as user 18, such that movements performed by the one or more users may be captured, analyzed, and tracked to perform one or more controls for the avatar 24, as will be described in more detail below.

According to one embodiment, the system 10 may be connected to an audiovisual device 16. The audiovisual device 16 may be any type of display, such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18 on a screen 14. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the system 10 may be used to recognize, analyze, and/or track a human target such as the user 18. For example, the user 18 may be tracked using the capture device 20 such that the position and movements of the user 18 may be interpreted as controls that may be used to affect the avatar 24 being displayed by the audiovisual display 16. Thus, the user 18 may move his or her body to control the avatar 24.

As shown in FIGS. 1A and 1B, in an example embodiment, the application executing on the computing environment 12 may be a boxing game that the user 18 may be playing. For example, the computing environment 12 may use the audiovisual device 16 to provide a view of a boxing opponent 22 to the user 18. The computing environment 12 may also use the audiovisual device 16 to provide a visual representation of the avatar 24 that the user 18 may control with his or her movements. For example, as shown in FIG. 1B, the user 18 may move his or her arm upward in physical space to control the avatar 24 to throw a punch in game space. Other movements of the user 18 may also be used to control the movement of the avatar 24. For example, in order to control the avatar 24 to move similarly, the user may make the following movements: bob, weave, shuffle, block, jab, or throw a variety of different power punches.

In example embodiments, movements of objects other than a user may be recognized, analyzed, and tracked for controlling movements of objects displayed by an audiovisual display. In such embodiments, the user of an electronic game may move an object to control movements of a corresponding display object. For example, the motion of a racket held by a user may be tracked and utilized for controlling an on-screen racket in an electronic sports game. In another example embodiment, the motion of an object held by a user may be tracked and utilized for controlling an on-screen weapon in an electronic combat game. Each of these objects and any other object such as a bat, a glove, a microphone, a guitar, drums, one or more balls, a stand, or the like may also be tracked and utilized and have a virtual screen associated with it. Such objects may be modeled with one or more registrations points, and movement filters applied as described herein for adaptively suppressing noise within the registration point positions captured by the system 10 such that movement of the a corresponding object on the audiovisual display 16 appears smooth.

According to other embodiment, the system 10 may further be used to interpret target movements as operating system and/or application controls that are outside the realm of games. For example, virtually any controllable aspect of an operating system and/or application may be controlled by movements of the target such as the user 18. Display objects that may be controlled via the user movements in accordance with the subject matter disclosed herein include avatars, game characters, cursors, windows, and the like. The adaptive noise suppression techniques described herein may be utilized in such application for providing smooth control movements on the audiovisual display 16.

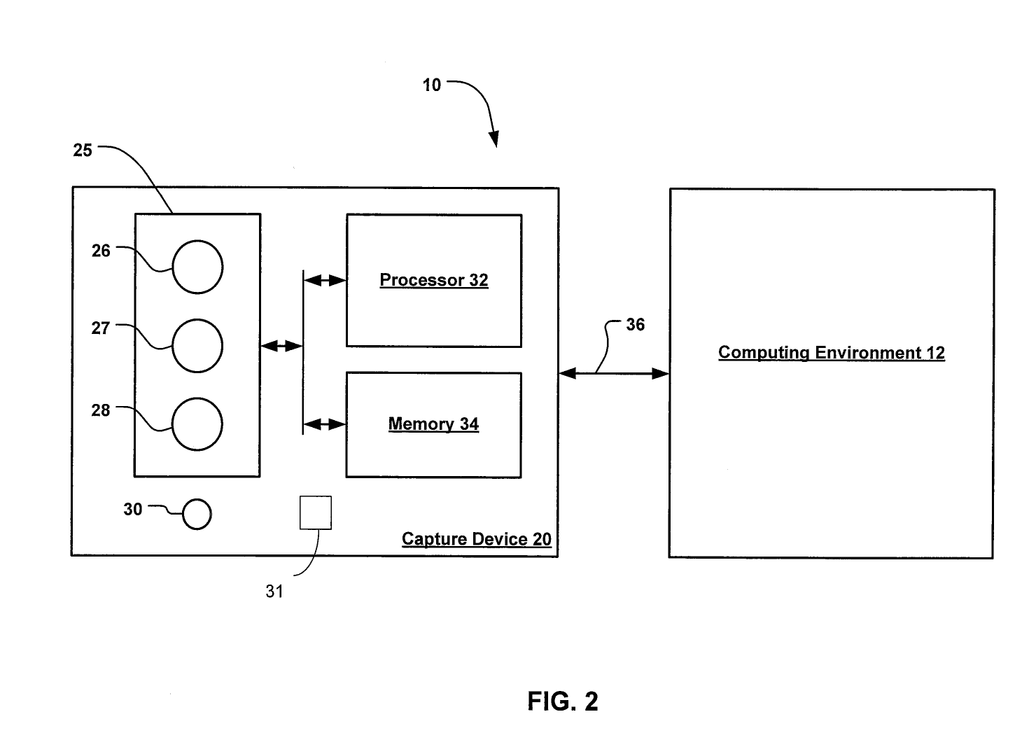

FIG. 2 illustrates an example embodiment of the capture device 20 that may be used in the system 10. According to the example embodiment, the capture device 20 may be configured to capture video with user movement information including one or more images that may include movement values via any suitable technique including, for example, time-of-flight, structured light, stereo image, or the like. According to one embodiment, the capture device 20 may organize the calculated movement information into coordinate information, such as X-, Y-, and Z-coordinate information. The coordinates of a user model, as described herein, may be monitored over time to determine a movement of the user or the user's appendages. Based on the movement of the user model coordinates, the computing environment may determine the velocity of the movement, as described herein.

As shown in FIG. 2, according to an example embodiment, the image camera component 25 may include an IR light component 26, a three-dimensional (3-D) camera 27, and an RGB camera 28 that may be used to capture a movement image(s) of a scene. For example, in time-of-flight analysis, the IR light component 26 of the capture device 20 may emit an infrared light onto the scene and may then use sensors (not shown) to detect the backscattered light from the surface of one or more targets and objects in the scene using, for example, the 3-D camera 27 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects. This information may also be used to determine user movement.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging. This information may also be used to determine user movement.

In another example embodiment, the capture device 20 may use a structured light to capture movement information. In such an analysis, patterned light (i.e., light displayed as a known pattern such as grid pattern or a stripe pattern) may be projected onto the scene via, for example, the IR light component 26. Upon striking the surface of one or more targets or objects in the scene, the pattern may become deformed in response. Such a deformation of the pattern may be captured by, for example, the 3-D camera 27 and/or the RGB camera 28 and may then be analyzed to determine a physical distance from the capture device to a particular location on the targets or objects.

According to another embodiment, the capture device 20 may include two or more physically separated cameras that may view a scene from different angles, to obtain visual stereo data that may be resolved to generate movement information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 25. The processor 32 may include a standardized processor, a specialized processor, a microprocessor, or the like that may execute instructions that may include instructions for receiving the user movement-related images, determining whether a suitable target may be included in the image(s), converting the suitable target into a skeletal representation or model of the target, including a skeletal tracking system or any other suitable instruction.

The capture device 20 may further include a memory component 34 that may store the instructions that may be executed by the processor 32, images or frames of images captured by the 3-D camera or RGB camera, player profiles or any other suitable information, images, or the like. According to an example embodiment, the memory component 34 may include random access memory (RAM), read only memory (ROM), cache, flash memory, a hard disk, or any other suitable storage component. As shown in FIG. 2, in one embodiment, the memory component 34 may be a separate component in communication with the image capture component 25 and the processor 32. According to another embodiment, the memory component 34 may be integrated into the processor 32 and/or the image capture component 25.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the movement information and images captured by, for example, the 3-D camera 27 and/or the RGB camera 28, and a skeletal model that may be generated by the capture device 20 to the computing environment 12 via the communication link 36. The computing environment 12 may then use the skeletal model, movement information, and captured images to, for example, create a virtual screen, adapt the user interface and control an avatar. For example, as shown, in FIG. 2, the computing environment 12 may store movement filters. The movement filters may be applied to suppress noise in the movement of registration points on a user's skeletal model, such that the movement of a corresponding point on the avatar appears smooth on the audiovisual device 16.

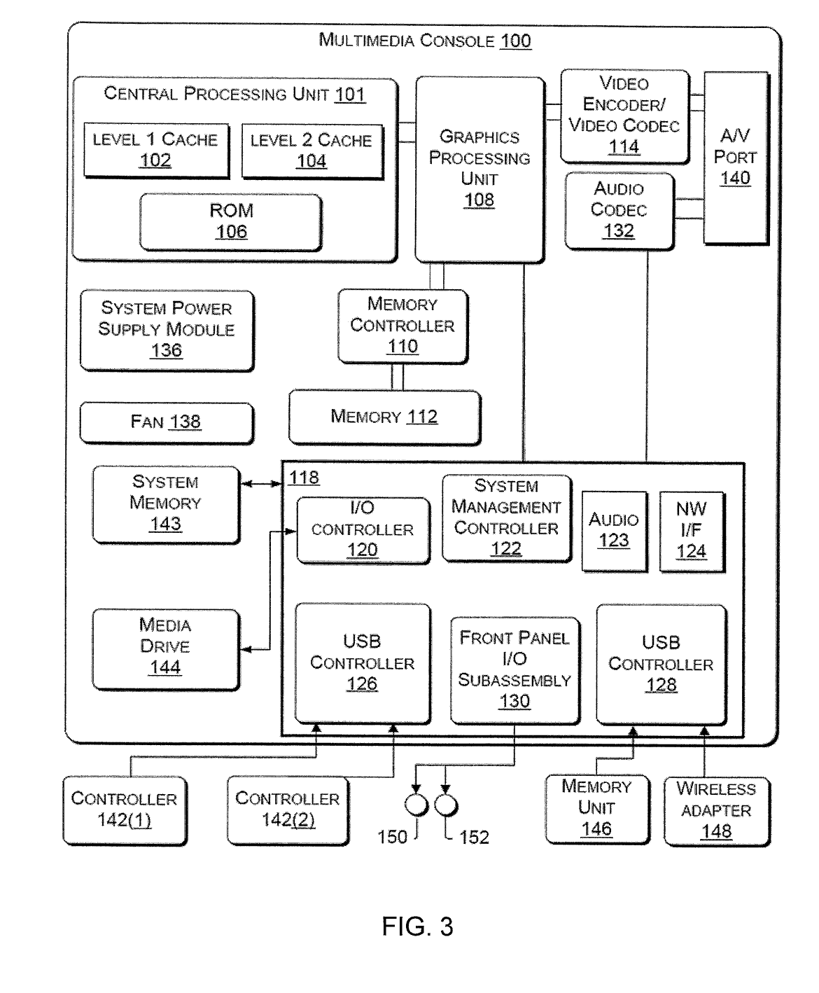

FIG. 3 illustrates an example embodiment of a computing environment that may be used to control movement of an avatar based on one or more user movements in a physical space. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 27, 28 and capture device 20 may define additional input devices for the console 100.

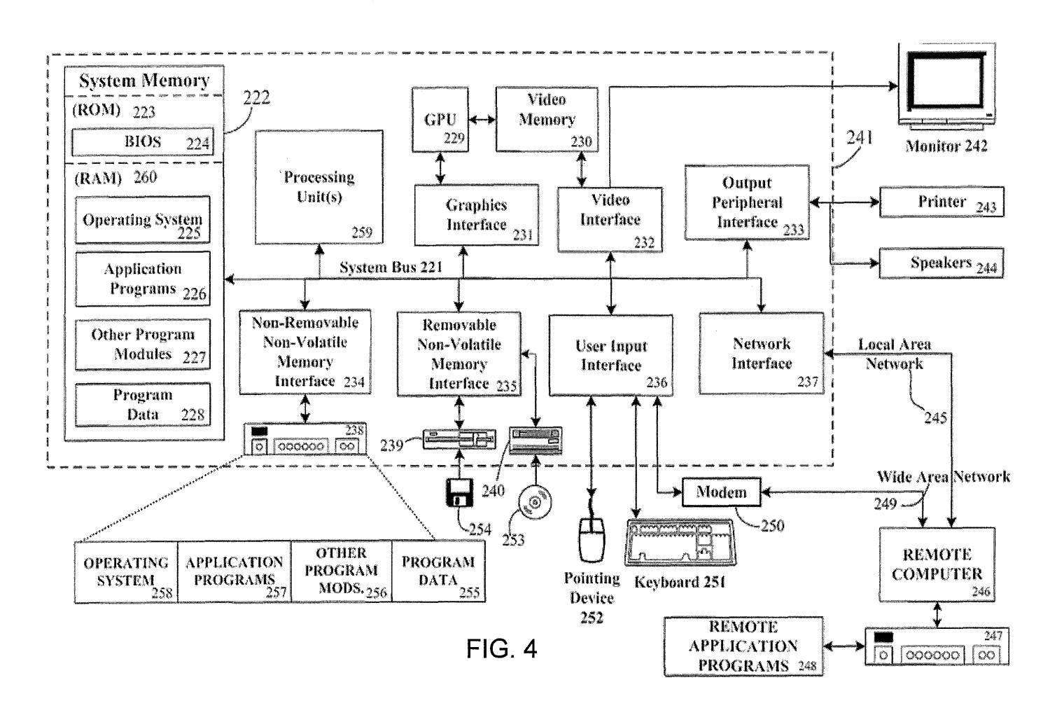

FIG. 4 illustrates another example embodiment of a computing environment 220 that may be the computing environment 12 shown in FIGS. 1A-2 used to control movement of an avatar based on one or more user movements in a physical space. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 27, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

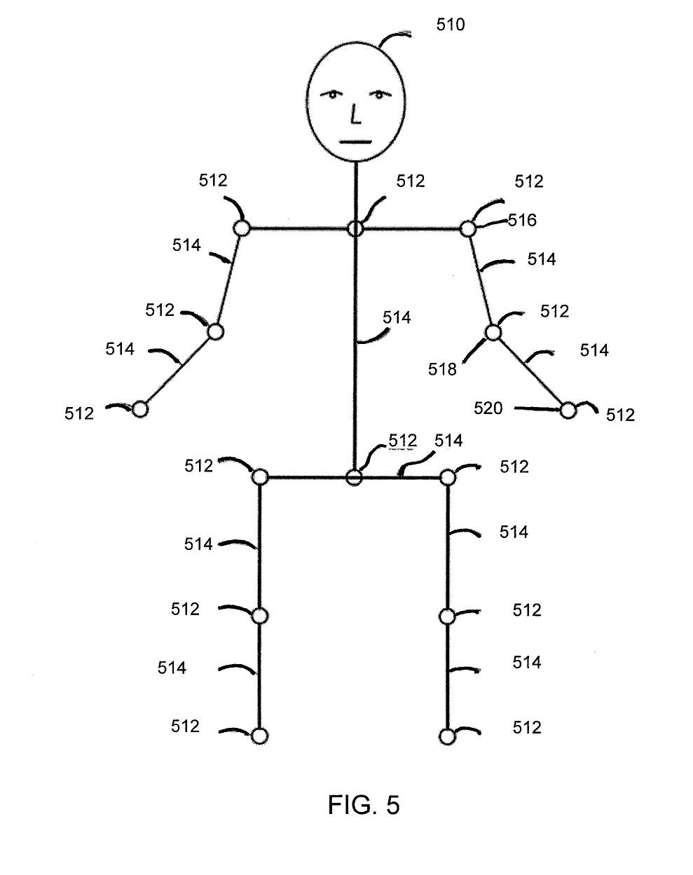

FIG. 5 depicts a model of a human user 510 that may be created using the capture device 20 and the computing environment 12. This model may be used by one or more aspects of the system 10 to determine user movements and the like. The model may be comprised of joints 512 and bones 514. Tracking movement of these joints and bones over time may allow the system 10 to determine the velocities of the joints and bones. These velocities may be used to control the movement of an avatar in the system 10 according to embodiments of the disclosed subject matter.

Different body parts of the user 18 shown in FIGS. 1A and 1B may be represented by the model of the human user 510 shown in FIG. 5. For example, one side of a shoulder of the user 18 may be represented by joint 516. The user's elbow and wrist may be represented by joints 518 and 520, respectively.

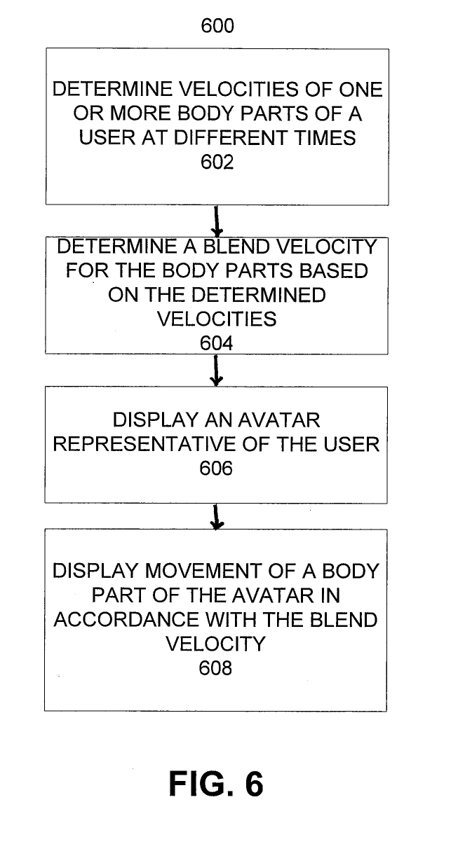

FIG. 6 depicts a flow diagram of an example method 600 for controlling movement of the avatar 24 or another display object based on movement of the user 18 shown in FIGS. 1A and 1B. The example method 600 may be implemented using, for example, the capture device 20 and/or computing environment 12 of the system 10 described with respect to FIGS. 1A-4. In one embodiment, the method 600 involves the steps of detecting the user 18, generating a model of the user 18 such as the model shown in FIG. 5, and binding the user 18 to the user's avatar 24.

The steps of the method 600 may be implemented sequentially in a loop for determining current movement for the avatar. Particularly, for each frame displayed of the avatar 24, the steps of method 600 may be performed for determining the movement of the avatar 24. Summarily, the velocities of one or more body parts of the user may be detected over a period of time, the velocities of each body part may be blended to determine a blend velocity based on the mean of the detected velocities over time, and the avatar may be displayed having movement in accordance with the blended velocities.

Referring now to step 602 of the method 600, the system 10 may determine velocities of one or more body parts of a user at different times. For example, if the user 18 moves his or her left wrist, the movement is detected by the capture device 20, and the joint 520 of the human user 510 will similarly move. The capture device 20 may capture frames of the wrist over a period of time. The velocities of the wrist movement in each captured frame may then be determined and buffered. The system 10 may also determine velocities of other joints 512 and bones 514.

At step 604, the system 10 may determine a blend velocity for each of the body parts based on the velocities determined at step 602. The blend velocity of a body part may be an average of the velocities of the body part over a period of time or over a number of previously-captured frames. For example, the blend velocity of a currently displayed movement of a wrist of an avatar may be an average of the velocities of a wrist of the user's model over a number of previously-captured frames. Depending on use of thresholds, movement of the user's model may exactly mimic or nearly mimic the movement of the user, while the movement of the avatar's body parts is at blend velocities of the user model's joints and/or bones. Alternatively, depending on the thresholds, the avatar's body parts may be moved in accordance with the frame velocity of the current frame.

In an example embodiment of determining a body part's blend velocity, the system 10 may determine and buffer a predetermined number of frame velocities of the body part of the user's model. Particularly, a current frame velocity and a predetermined number of the last frame velocities for each body part of a user's model may be buffered in a memory of the system 10. For example, a current frame velocity and four (4) or any other number of suitable previous frame velocities of a body part may be stored at any particular time. The current frame velocity may be an estimated velocity of the user body part based on a current frame and/or one or more previously-captured frames of a captured video of the user's body part. The historical frame velocities may be estimated velocities of the user body part based on one or more previously-captured frames. The current frame velocity and historical frame velocities may be used by a movement filter for determining the blend velocity. Particularly, the movement filter may compare the current frame velocity to the historical frame velocities using one or more threshold values for determining movement of the corresponding body part of the avatar.

In an example of determining the blend velocity for a body part, the process may include using a dot product of the current frame velocity and a mean of the historical frame velocities of the body part for determining whether the current frame velocity is a good match or a bad match. The dot product of the current frame velocity and the dot product of the mean of the historical frame velocities are compared using one or more thresholds to determine whether the current frame velocity is a good or bad match. A good match may refer to a condition wherein the difference between the current frame velocity and the mean of the historical frame velocities is less than a predefined threshold value. According to one embodiment, the dot product threshold may be 0.2. The threshold may be scale independent and the main criteria for determining whether the current velocity is aligned with the historical average. Thus, in the case of a good match, it may be assumed that currently-captured movement of the body part is actually moving in the detected manner since the movement is similar to the mean movement, or that such movement is not noise. A bad match may refer to a condition wherein the difference between the current frame velocity and the historical frame velocities is greater than a predefined threshold value. Thus, in the case of a bad match, it may be assumed that currently-captured movement of the body part is not actually moving in the detected manner since the movement is similar to the mean movement, or that such movement should be suppressed.

If the condition is a good match, the corresponding body part of the avatar may be moved in accordance with the current frame velocity. As described herein above, the mean velocity over a number of captured frames tends to zero in the steady state, and the mean velocity over a number of captured frames tends to the actual velocity of the user's movement in the moving state. If the condition is a bad match, the corresponding body part of the avatar may be moved in accordance with the mean of the historical frame velocities.

At step 606, the system 10 may display the avatar. For example, an avatar corresponding to the model shown in FIG. 5 may be displayed via the audiovisual display 16. The displayed avatar's body part may be moved in accordance with its determined blend velocity. For example, in the case of a good match, in a next-displayed frame of the avatar, the avatar's body part may be moved in accordance with the current frame velocity. In the case of a bad match, the avatar's body part may be moved in accordance with the mean of the historical frame velocities.

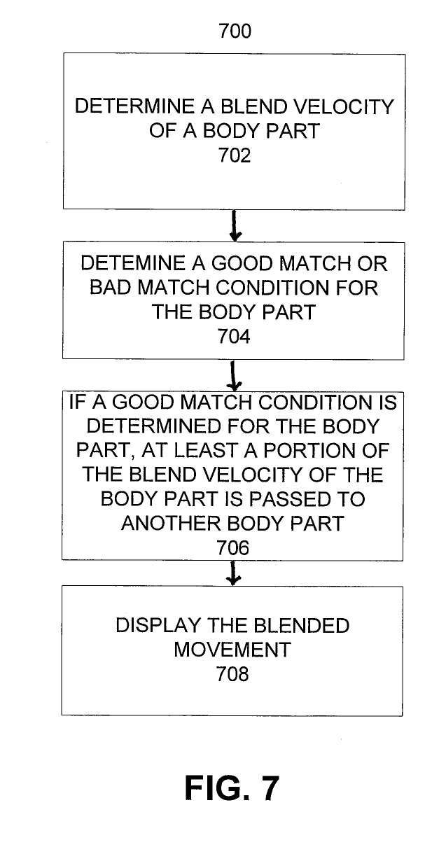

According to one embodiment, a blend velocity for one body part may be used for determining a velocity of another body part. For example, FIG. 7 depicts a flow diagram of an example method 700 for controlling movement of a body part of the avatar 24 based on movement of another body part. The example method 700 may be implemented using, for example, the capture device 20 and/or computing environment 12 of the system 10 described with respect to FIGS. 1A-4.

At step 702, the system 10 may determine a blend velocity of a body part, such as wrist 520 shown in FIG. 5. For example, the blend velocity for the wrist 520 may be determined in accordance with the example method 600 of FIG. 6.

At step 704, the system 10 may determine a good match or bad match condition for the body part. If a good match condition is determined for the body part, at least a portion of the blend velocity of the body part is passed to another body part at step 706. For example, a portion of the blend velocity of the wrist 520 may be passed to the elbow 518 and/or shoulder 516 if it is determined the wrist 520. The other body part may be displayed with the blended movement at step 708. For example, the elbow 518 and/or shoulder 516 may be displayed with the blended movement of the wrist 520.

The example method 700 may be useful in reducing or eliminating jitter or jumping in body parts moving with bad matches when it is known that another body part is moving with a good match. For example, when a user is waving his or her arm with the wrist moving and the elbow being held steady, there may be noticeable issue with the elbow position jumping. This may be due to the wrist joint moving with a good match, but the elbow moving very slowly with mostly bad matches and the jump occurring on the occasional good match. The real movement of the elbow may be lost among the noise. If one end of a bone is known to be moving genuinely by instance of a good match, the other can be expected to be affected as well. In the case of a good match, additional passes may be made over the blend values, and a proportion of the blend value passed along to each connected joint. For example, if the wrist is moving with a high blend velocity, some of the blend velocity is passed to the elbow and then on to the shoulder. Such an approach may remove jumpy elbows and knee joints without letting through any apparent jitter.

According to an example embodiment, the blend velocities for a joint may be stored over a period of time and blended over a number of frames. For example, the system 10 may buffer a number of previous blend velocities of a wrist. The buffered blend velocities may be blended over a number of the next-displayed frames of the avatar. For example, the blending of the blend velocities may include averaging the blended velocities. The averaged blended velocities may be used as movement for the avatar in the next frame to be displayed. Such an approach may be useful in reducing jitter or joint jumping across a transition from a slow user joint movement, which may result in a bad match, to a fast user joint movement, which may result in a good match. In this case, the jitter or jumping may be due to, for example, the blend velocity suddenly jumping from a bad match velocity to the dot product velocity. For example, this may be the case when a user waves his arms but speeds up and slows down during each stroke. This approach may smooth the transition very effectively without introducing noticeable lag.

According to an example embodiment, the current velocity and historical average velocity of an object must have a velocity above predetermined threshold values or otherwise considered to be at zero (0) velocity. Thus, if the current velocity or the historical average velocity is below the threshold value, the velocity may be assumed to be not very informative, and set to the velocity value of 0. In an example, a threshold value for the current velocity may be 0.02 in magnitude. In another example, a threshold value for the historical average velocity may be 0.05 in magnitude. These threshold values may prevent imperceptible changes in position from being applied.

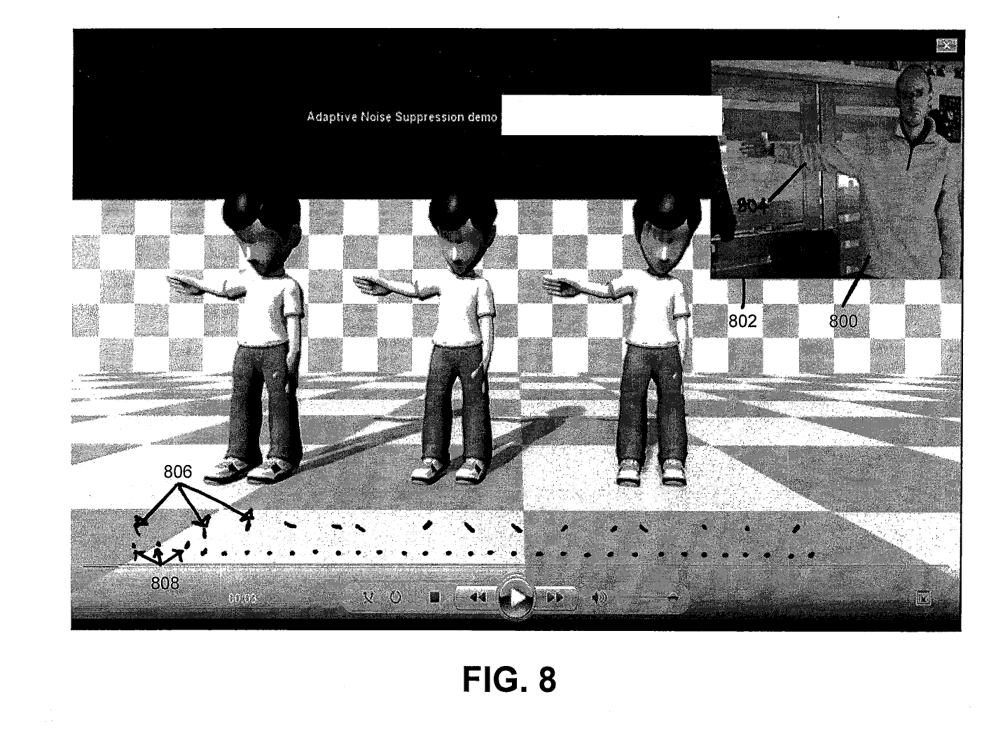

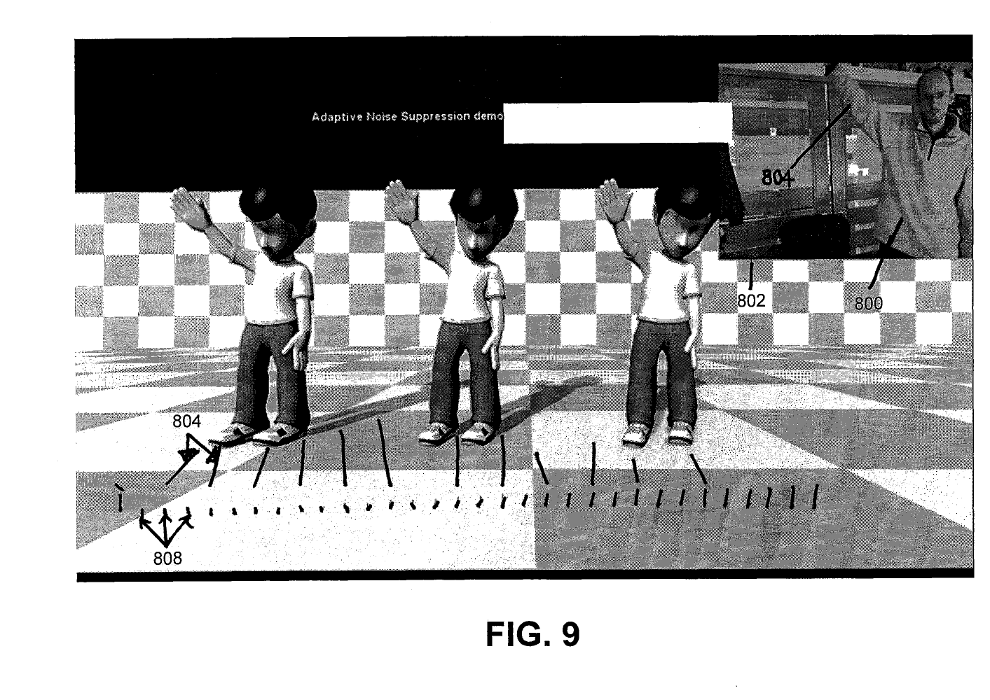

FIGS. 8 and 9 are screen displays of an avatar facing the user along with graphics of velocity magnitudes of the wrist movement and their averages over a period of time. Referring to FIG. 8, a user 800 is shown in a window 802. The user 800 is maintaining his wrist in a stationary position 804 over the time period. Ticks 806 along a horizontal axis of the display graphically show the magnified velocity vector of the wrist 804 at different captured frames. Corresponding ticks 808 are positioned below the ticks 806 and show the averaged history of the frames. Ticks 808 show essentially no real movement of the wrist. Thus, by application of the processes disclosed herein, averaging of the velocities of the elbow over a period of time may help to prevent jitter in the wrist movement.

In FIG. 9, the user 800 is raising his arm. The ticks 806 demonstrate this movement in each frame. Also, ticks 808 show the average velocity that may be used in moving the avatar.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Additionally, the subject matter of the present disclosure includes combinations and subcombinations of the various processes, systems and configurations, and other features, functions, acts, and/or processes disclosed herein, as well as equivalents thereof.

What is claimed:

1. A method for controlling a display object, the method comprising:
determining a plurality of velocities of at least one body part of a user at different times;
determining, based on the determined velocities, a blend velocity for the at least one user body part;
displaying a display object, and
controlling the display object in accordance with the blend velocity.

2. The method of claim 1 wherein the blend velocity is an average of the velocities over a period of time, and
wherein controlling the display object comprises moving a body part of an avatar at the average of the velocities.

3. The method of claim 1 wherein determining a plurality of velocities further comprises determining a current frame velocity and historical frame velocities of the at least one user body part, and
wherein determining a blend velocity comprises:
comparing the current frame velocity to the historical frame velocities using at least one threshold value; and
determining, based on the comparison, movement of the display object in a frame.

4. The method of claim 1 wherein determining a plurality of velocities further comprises determining a current frame velocity and historical frame velocities of the at least one user body part, and
wherein the method further comprises:
determining a dot product of the current frame velocity and a dot product of a mean of the historical frame velocities;
comparing the dot products using a threshold; and
based on the thresholds, determining movement of the display object.

5. The method of claim 4 wherein the current frame velocity is an estimated velocity of the user body part based on a current frame of a captured video of the user, and
wherein the historical frame velocities are estimated velocities of the user body part based on frames captured on the captured video prior to the current frame.

6. The method of claim 1 wherein determining a plurality of velocities further comprises determining a current frame velocity and historical frame velocities of the at least one user body part, and
the method further comprising:
comparing the current velocity to the historical frame velocities; and
based on the comparison of the current velocity to the historical frame velocities, determining movement of another display object, and displaying movement of the another display object in accordance with the determined movement.

7. The method of claim 1 wherein displaying display object comprises displaying an avatar, and wherein displaying movement of the display object comprises displaying movement of a body part of the avatar in accordance with the blend velocity.

8. The method of claim 1 further comprising:
storing blend velocities for the at least one use body part over a period of time; and
averaging the blend velocities, and
wherein controlling the display object comprises displaying movement of the display object in accordance with the averaged blend velocities.

9. A computer readable medium having stored thereon computer executable instructions for controlling a display object, comprising:
determining a plurality of velocities of at least one body part of a user at different times;
determining, based on the determined velocities, a blend velocity for the at least one user body part;
displaying a display object, and
controlling the display object in accordance with the blend velocity.

10. The computer readable medium of claim 9 wherein the blend velocity is an average of the velocities over a period of time, and
wherein controlling the display object comprises moving a body part of an avatar at the average of the velocities.

11. The computer readable medium of claim 9 wherein determining a plurality of velocities further comprises determining a current frame velocity and historical frame velocities of the at least one user body part, and
wherein determining a blend velocity comprises:
comparing the current frame velocity to the historical frame velocities using at least one threshold value; and
determining, based on the comparison, movement of the display object in a frame.

12. The computer readable medium of claim 9 wherein determining a plurality of velocities further comprises determining a current frame velocity and historical frame velocities of the at least one user body part, and
wherein the computer executable instructions further comprise:
determining a dot product of the current frame velocity and a dot product of a mean of the historical frame velocities;
comparing the dot products using a threshold; and
based on the thresholds, determining movement of the display object.

13. The computer readable medium of claim 12 wherein the current frame velocity is an estimated velocity of the user body part based on a current frame of a captured video of the user, and
wherein the historical frame velocities are estimated velocities of the user body part based on frames captured on the captured video prior to the current frame.

14. The computer readable medium of claim 9 wherein determining a plurality of velocities further comprises determining a current frame velocity and historical frame velocities of the at least one user body part, and
the computer executable instructions further comprising:
comparing the current velocity to the historical frame velocities; and
based on the comparison of the current velocity to the historical frame velocities, determining movement of another display object, and displaying movement of the another display object in accordance with the determined movement.

15. The computer readable medium of claim 9 further comprising:
storing blend velocities for the at least one use body part over a period of time; and
averaging the blend velocities, and
wherein controlling the display object comprises displaying movement of the display object in accordance with the averaged blend velocities.

16. A system for controlling a display object, the system comprising:
a computing device for:
determining a plurality of velocities of at least one body part of a user at different times; and
determining, based on the determined velocities, a blend velocity for the at least one user body part; and
a display for:
displaying a display object, and
controlling the display object in accordance with the blend velocity.

17. The system of claim 16 wherein the blend velocity is an average of the velocities over a period of time, and
wherein controlling the display object comprises moving a body part of an avatar at the average of the velocities.

18. The system of claim 16 wherein determining a plurality of velocities further comprises determining a current frame velocity and historical frame velocities of the at least one user body part, and
wherein determining a blend velocity comprises:
comparing the current frame velocity to the historical frame velocities using at least one threshold value; and
determining, based on the comparison, movement of the display object in a frame.

19. The system of claim 16 wherein determining a plurality of velocities further comprises determining a current frame velocity and historical frame velocities of the at least one user body part, and
wherein the computing device is operable to:
determine a dot product of the current frame velocity and a dot product of a mean of the historical frame velocities;
compare the dot products using a threshold; and
determine movement of the display object based on the thresholds.

20. The system of claim 16 wherein determining a plurality of velocities further comprises determining a current frame velocity and historical frame velocities of the at least one user body part, and
wherein the computing device is operable to:
compare the current velocity to the historical frame velocities; and
based on the comparison of the current velocity to the historical frame velocities, determine movement of another display object, and displaying movement of the another display object in accordance with the determined movement.
